(19) United States
(12) Patent Application Publication
(10) Pub. No.: US 2025/0059885 A1
(43) Pub. Date: Feb. 20, 2025

(54) COMPOSITIONS COMPRISING PROPPANT PARTICULATES HAVING ENCAPSULATED MICRODEVICES AND METHODS FOR USE THEREOF

(71) Applicant: SAUDI ARABIAN OIL COMPANY, Dhahran (SA)

(72) Inventor: Wael O. BADEGHAISH, Dhahran (SA)

(73) Assignee: SAUDI ARABIAN OIL COMPANY, Dhahran (SA)

(21) Appl. No.: 18/451,777

(22) Filed: Aug. 17, 2023

(51) Int. Cl. E21B 49/00; C09K 8/80; C09K 8/92; E21B 43/267; E21B 47/12

(52) U.S. Cl. CPC E21B 49/00; C09K 8/805; C09K 8/92; E21B 43/267; E21B 47/138

(57) ABSTRACT

Proppant particulates may comprise a polymer material and a microdevice encapsulated within the polymer material. Compositions may comprise a carrier fluid and a plurality of the proppant particulates dispersed within the carrier fluid. Methods may comprise providing the composition containing the plurality of the proppant particulates, introducing the composition into a subterranean formation at or above a fracture gradient pressure to form a plurality of fractures therein, allowing at least a portion of the plurality of proppant particulates to settle in the plurality of fractures, and interrogating the plurality of proppant particulates to determine at least one attribute of the plurality of fractures.

### FIELD OF THE DISCLOSURE

The present disclosure relates generally to subterranean stimulation operations and, more particularly, to proppant particulates that may be interrogated for determining hydraulic fracture attributes.

### BACKGROUND OF THE DISCLOSURE

Hydrocarbon-producing wells (e.g., oil-producing wells, gas-producing wells, and the like) are often stimulated using hydraulic fracturing treatments. In traditional hydraulic fracturing treatments, a fracturing fluid containing proppant particulates entrained therein is pumped into a portion of a subterranean formation above a fracture gradient pressure sufficient to expand the formation matrix and create or extend one or more fractures therein. The fractures increase the permeability of the formation matrix and allow the production of hydrocarbons to take place more easily.

During fracturing operations, the proppant particulates may enter the fractures while the fractures remain open under high hydraulic pressures. Once the hydraulic pressure is released, the proppant particulates prevent the fractures from fully closing, thereby allowing the increased formation matrix permeability to be at least partially maintained. By keeping the fractures from fully closing, the proppant particulates within the fractures form a proppant pack having interstitial spaces that provide a conductive path through which fluids may flow for production from the formation.

Among numerous factors, the success of a fracturing treatment may rely on the proper placement of the proppant particulates within a plurality of fractures to form a suitable proppant pack. However, direct measurement of the dimensions of a hydraulic fracture or the integrity of a proppant pack is difficult at best. Conventionally used methods for analyzing fractures for mapping purposes may include pressure analysis, tiltmeter observational analysis, and microseismic monitoring of hydraulic fracture growth. Each of these techniques utilizes time-consuming modeling and data deconvolution. As such, there is considerable uncertainty in the true nature of fractures in a given circumstance. Variability in the rock properties, or the fracturing process itself, may further negatively impact the quality of the data collected using these methods. In addition, these techniques also provide little information on the actual shape of a propped fracture.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments consistent with the present disclosure, proppant particulates may comprise a polymer material, and a microdevice encapsulated within the polymer material.

In other embodiments, compositions may comprise a carrier fluid and a plurality of proppant particulates dispersed within the carrier fluid, at least a portion of the proppant particulates comprising a polymer material and a microdevice encapsulated within the polymer material.

In still other embodiments, fracturing methods may comprise providing a composition containing a plurality of the proppant particulates; introducing the composition into a subterranean formation at or above a fracture gradient pressure to form a plurality of fractures therein; allowing at least a portion of the plurality of proppant particulates to settle in the plurality of fractures; and interrogating the plurality of proppant particulates to determine at least one attribute of the plurality of fractures.

Any combination of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A is a cross-sectional diagram of a proppant particulate having a microdevice encapsulated within a polymer material. FIG. 1B is a cross-sectional diagram of a proppant particulate having a core particle encapsulated by a coating comprising a polymer material, in which the coating further encapsulates a microdevice.

FIG. 2 is a diagram of a well site having a hydraulic fracturing system.

FIG. 3 is a diagram of a fracture containing a plurality of proppant particulates.

### DETAILED DESCRIPTION

Embodiments in accordance with the present disclosure generally relate to subterranean stimulation operations and, more particularly, to proppant particulates that may be interrogated for determining hydraulic fracture attributes.

The present disclosure addresses various deficiencies of currently available hydraulic fracture mapping techniques. In particular, the present disclosure overcomes the foregoing deficiencies by encapsulating microdevices within polymeric proppant particulates. In the present disclosure, the terms “proppant particulates” and “proppant” are used interchangeably to refer to particles that are mixed with a fracturing fluid to hold fractures open after the particulates have become localized in fractures and the hydraulic pressure has been released. The microdevices may be used to detect various conditions within the fractures, thereby allowing specific fracture attributes to be mapped. Advantageously, fracture mapping with improved accuracy accessible through the disclosure herein may help ensure proper proppant placement and fracture geometry are realized, which may promote improved hydrocarbon extraction from a subterranean formation.

Microdevice-encapsulated proppant particulate compositions and methods thereof are described herein. Microdevices, such as RFID semiconductor chips or MEMS sensors, encapsulated within polymer-based proppant particulates may be utilized in conventional hydraulic fracturing techniques to analyze the formed fractures, which may include fracture mapping or determining proppant pack density. Once the microdevice-encapsulated proppant particulates settle in a plurality of fractures, the proppant particulates may be interrogated, such as by a reader, to obtain information transmitted by the microdevices. This transmitted information may be used to determine at least one attribute of the plurality of fractures. All of the proppant particulates introduced into a subterranean formation during a fracturing operation need not necessarily be microdevice-encapsulated proppant particulates. Instead, the microdevice-encapsulated proppant particulates of the present disclosure may be combined with ordinary proppant particulates (e.g., sand or similar types of particulates) lacking a microdevice according to one or more embodiments.

Accordingly, proppant particulates of the present disclosure may comprise a polymer material, and a microdevice encapsulated within the polymer material. Suitable microdevices may include any electronic device that fits within the physical dimensions of a given proppant particulate, or a portion thereof. For example, when a polymer material coats a core particle, the microdevice may be encapsulated within the coating. In non-limiting examples, suitable microdevices may include, for example, a radio frequency identification (RFID) semiconductor chip, a microelectromechanical system (MEMS) sensor, a camera, a temperature sensor, a conductivity sensor, or any combination thereof. Depending on the type of attribute that is to be determined during or following a fracturing operation, one having ordinary skill in the art will be able to choose an appropriate microdevice for determining the attribute. More than one microdevice may be encapsulated by a polymer material in a given proppant particulate, or blends of proppant particulates containing different encapsulated microdevices may be used.

Proppant particulates comprising a polymer material may be particularly advantageous in hydraulic fracturing techniques due to the low density and weight of the polymer material. Conventional proppant particulates commonly contain dense solids such as sand, fragments of nut shells, ceramics, and the like. These conventional proppants must often be suspended in highly viscous carrier fluids to form a homogenous mixture that is then conveyed into a subterranean formation. Resultantly, the mixture of viscous carrier fluid and conventional proppant particulates is injected into a hydrocarbon-producing well at a significantly high pressure. Polymer-based proppants, however, sometimes may not require viscous carrier fluids due to the low density of the polymer, thus allowing for lower injection pressures (but above the fracture gradient pressure) and less dense carrier fluids. Additionally, the polymer material may serve as a barrier to protect the microdevice from aggressive downhole conditions. In non-limiting examples, polymer materials such as pliable thermoplastics and/or vitrimers may simultaneously protect the microdevice and enhance penetration of the proppant particulates within fractures.

Radio frequency identification (RFID) technologies are commonly used in various industries to identify and track objects within a system. Microdevices relying upon RFID semiconductor chip technology may contain unique identification data stored upon the semiconductor chip. When the semiconductor chip is within range of an RFID reader, the semiconductor chip may receive a radio signal from the RFID reader and emit a response. The response containing the identification data is captured by the reader and transmitted to a central database or computer for further data manipulation. The identification data received by an RFID reader placed in a subterranean formation may be utilized to determine one or more fracture attributes according to the disclosure herein.

Microelectromechanical system (MEMS) sensors may similarly be used to track objects within a system. MEMS sensors contain small mechanical structures that respond to physical inputs such as motion, temperature, and/or pressure and are in electrical communication with a circuit to detect a response. When the mechanical structure moves or deforms in response to a stimulus, the resulting change in structure also changes the electrical properties of the circuit. By comparing against known values, the magnitude of the change in electrical properties may be used to quantify the physical property being measured. MEMS sensors may likewise be utilized to determine physical changes, such as pressure or fracture width changes, that are occurring within a subterranean formation.

Proppant particulates, when containing a microdevice, may be interrogated to determine at least one attribute of the plurality of fractures in which at least a portion of the plurality of proppant particulates have settled. The microdevices may, for example, be able to determine attributes, such as a geometry of the plurality of fractures, a depth of the plurality of fractures relative to the Earth's surface, a pressure, or any combination thereof. Similarly, a temperature sensor may be incorporated into the microdevice. In this instance, the attribute of the plurality of fractures would be a temperature. The microdevice may still further comprise a camera or a conductivity sensor to observe fracture conditions such as fluid flow or occlusion. Visual images of a fracture may also be useful in some instances. These data may be used to map the plurality of fractures and determine the productivity of the well.

Preferably, the microdevice may lack a power source and may be interrogated by an input received from an external device. For example, the microdevice may be a passive RFID semiconductor, which may be interrogated by an input of energy from a RFID reader.

The proppant particulates of the present disclosure may comprise a polymer material that encapsulates and protects the microdevice. In some embodiments, the polymer material may comprise a deformable thermoplastic polymer, such as polyetherimide. Preferably, the polymer material may be optically transparent to assist in operating or interrogating the microdevice. Other suitable thermoplastic polymers that may be utilized in the proppant particulates of the present disclosure for encapsulating a microdevice include, but are not limited to, polyethylene, polypropylene, ethylene vinyl acetate, ethylene ethyl acrylate, styrene-isoprene-styrene, acrylonitrile-butadiene-styrene, styrene-butadiene-styrene, polystyrene, polyurethane, an acrylic polymer, polyvinyl chloride, a fluoroplastic, pine rosin (e.g., tall oil rosin, wood rosin, or gum rosin), modified rosin (e.g., disproportionated rosins, hydrogenated rosins, polymerized or oligomerized rosins, or Diels-Alder rosin adducts), a rosin ester (e.g., hydrogenated rosin esters, polymerized rosin esters, phenolic-modified rosin esters, or dibasic acid-modified rosin esters), a polysulfide, styrene-acrylonitrile, nylon, a phenol-formaldehyde novolac resin, the like, and any combination thereof.

Alternately, the polymer material within the proppant particulates disclosed herein may comprise a thermosetting polymer, particularly a vitrimer. Vitrimers are a special type of thermosetting polymer that may define a covalent adaptable network (CAN) having crosslinked polymer chains, whose structure may deform in response to a stimulus and produce a detectable signal in response to the stimulus. Although technically thermosetting polymers, vitrimers may possess similar qualities to thermoplastic polymers including high processability, repairability, and performance. Examples of suitable vitrimers for use in the present disclosure may include, but are not limited to, epoxy resins based on diglycidyl ether of bisphenol A, aromatic polyesters, polylactic acid, polyhydroxyurethanes, epoxidized soybean oil, polybutadiene, the like, and any combination thereof. An appropriate epoxy curing agent may be paired with any of the foregoing.

Proppant particulates comprising vitrimers and similar materials may sometimes lack an encapsulated microdevice. Such proppant particulates may respond in a desired way to particular downhole conditions, such as temperature. For example, vitrimer-containing proppant particulates may expand or contract downhole to increase or decrease fluid flow within a fracture.

Furthermore, the polymer material may sometimes comprise both a thermoplastic polymer, such as a polyetherimide, and a vitrimer as components.

Regardless of composition, suitable polymer materials may be selected to possess both high thermal stability and compressive strength to withstand downhole conditions during a fracturing operation, thereby remaining effective for maintaining a fracture in an open state and also protecting a microdevice encapsulated therein. In non-limiting examples, the polymer material may be thermally stable over a temperature ranging from about 20° C. to about 240° C., or about 20° C. to about 200° C., or about 20° C. to about 160° C., or about 20° C. to about 120° C., or about 120° C. to about 240° C., or about 120° C. to about 200° C., or about 120° C. to about 160° C., or about 160° C. to about 240° C., or about 160° C. to about 200° C., or about 200° C. to about 240° C. In addition or alternately, the polymer material may have a compressive strength of about 30,000 psi to about 35,000 psi, or about 30,000 psi to about 34,000 psi, or about 30,000 psi to about 33,000 psi, or about 30,000 psi to about 32,000 psi, or about 30,000 psi to about 31,000 psi, or about 31,000 psi to about 35,000 psi, or about 31,000 psi to about 34,000 psi, or about 31,000 psi to about 33,000 psi, or about 31,000 psi to about 32,000 psi, or about 32,000 psi to about 35,000 psi, or about 32,000 psi to about 34,000 psi, or about 32,000 psi to about 33,000 psi, or about 33,000 psi to about 35,000 psi, or about 33,000 psi to about 34,000 psi, or about 34,000 psi to about 35,000 psi.

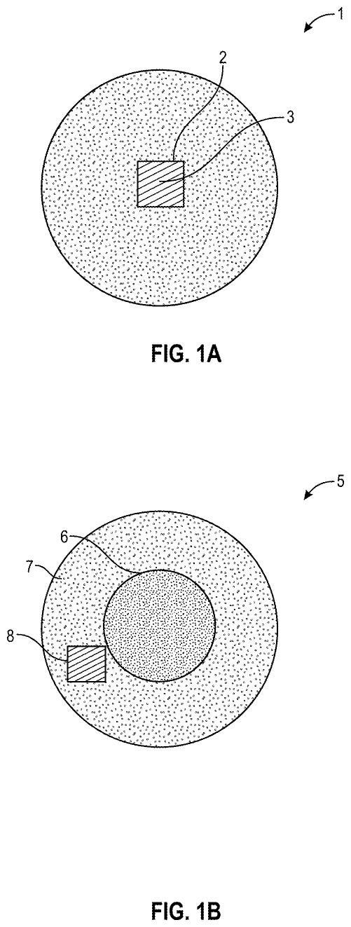

The proppant particulates of the present disclosure may consist solely of the polymer material and the microdevice. FIG. 1A is a cross-sectional diagram of proppant particulate 1 having microdevice 3 encapsulated within polymer material 2.

The proppant particulates may also comprise other materials, including one or more conventional proppant materials, as core particles that are coated with the polymer material. FIG. 1B is a cross-sectional diagram of proppant particulate 5 having core particle 6 encapsulated by coating 7 comprising a polymer material. Coating 7 further encapsulates microdevice 8 above a surface of core particle 6. Core particle 6 may include any suitable proppant material used in hydraulic fracturing. For example, suitable core particles 6 may comprise silica flour, ceramic (e.g., ceramic microspheres), glass (e.g., glass microspheres), cenospheres, shells (e.g., nut shells), seeds, fruit pit materials, sand (e.g., natural sand or quartz sand), gravel, cement, garnet (e.g., particulate garnet), metal (e.g., metal particulates or beads), glass, nylon (e.g., nylon pellets), wood (e.g., processed wood), ore (e.g., bauxite or other ores), polymer materials other than the polymer material in the coating, composite materials including at least one of silica, alumina, fumed silica, carbon black, graphite, mica, titanium dioxide, meta-silicate, calcium silicate, kaolin, talc, zirconia, boron, fly ash, or any combination thereof.

The proppant particulates of the present disclosure may be of any size and shape combination suitable for use in a hydraulic fracturing operation. The shape may be substantially spherical or substantially non-spherical. Suitable substantially non-spherical proppant particulates may be cubic, polygonal, fibrous, or any other non-spherical shape. Such substantially non-spherical proppant particulates may, for example, be cubic-shaped, rectangular-shaped, rod-shaped, ellipse-shaped, helix-shaped, cone-shaped, pyramid-shaped, or cylinder-shaped. Any of the foregoing shapes may comprise a vitrimer. To achieve the desired shape, the proppant particulates may be formed by techniques including, but not limited to, 3D printing, 4D printing, injection molding, the like, and any combination thereof.

At least one dimension of the proppant particulates, whether substantially spherical or substantially non-spherical, may be sufficiently small so that a plurality of proppant particles may be able to settle in a plurality of fractures. For example, a dimension of the proppant particulates may be about 1 mm to about 3 mm, or about 1 mm to about 2.5 mm, or about 1 mm to about 2 mm, or about 1 mm to about 1.5 mm, or about 1.5 mm to about 3 mm, or about 1.5 mm to about 2.5 mm, or about 1.5 mm to about 2 mm, or about 2 mm to about 3 mm, or about 2 mm to about 2.5 mm, or about 2.5 mm to about 3 mm. In the instance in which the proppant particulates are substantially spherical, the dimension may be a diameter of the proppant particulates. For substantially non-spherical proppant particulates, the dimension may be a length of the longest axis of the proppant particulates.

The proppant particulates of the present disclosure may further be incorporated in a carrier fluid to define a fracturing fluid. Compositions defining a fracturing fluid may comprise a carrier fluid, and a plurality of proppant particulates dispersed within the carrier fluid, in which at least a portion of the proppant particulates comprise a polymer material and a microdevice encapsulated within the polymer material.

Suitable carrier fluids may include, for example, any mixture of water and, optionally, a water-miscible organic solvent, such as an alcohol or glycol. Additionally, various other additives may be present in the carrier fluid suitable for use in the present disclosure. For example, gelling agents (e.g., viscosifying polymers) may be included in a carrier fluid to increase the fluid's viscosity, which may be desirable for some applications. A viscosified fracturing fluid may be better suited to transport significant quantities of suspended proppant particulates. However, viscosification may not needed if the proppant particulates are not overly dense, as may be the case for polymeric proppant particulates, including those containing a microdevice according to the present disclosure. Suitable gelling agents may include, but are not limited to, a hydratable polymer or crosslinkable polymer including, but not limited to, galactomannan gums, cellulose derivatives, combinations thereof, derivatives thereof, and the like. Particular examples may include, for example, gum Arabic, gum ghatti, gum karaya, tamarind gum, tragacanth gum, guar gum, locust bean gum, hydroxyethylguar, hydroxypropylguar, carboxymethylguar, carboxymethylhydroxyethylguar, carboxymethylhydroxypropylguar, hydroxyethylcellulose, carboxyethylcellulose, carboxymethylcellulose, carboxymethylhydroxyethylcellulose, any derivative thereof, or any combination thereof. Crosslinkable polymers suitable for inclusion in the fracturing fluids of the present disclosure may be naturally occurring and/or synthetic and contain one or more functional groups such as hydroxyl, carboxyl, sulfate, sulfonate, phosphate, phosphonate, amino, or amide groups. The functional groups may be crosslinked by a reaction with a suitable crosslinking agent, examples of which will be familiar to persons having ordinary skill in the art.

It is also to be appreciated that other various additives may be included in the carrier fluids. Suitable additives that may be optionally present include, but are not limited to, salts, acids, fluid loss control additives, gas, foamers, corrosion inhibitors, scale inhibitors, catalysts, biocides, friction reducing polymers, iron control agents, antifoam agents, bridging agents, dispersants, hydrogen sulfide scavengers, carbon dioxide scavengers, oxygen scavengers, lubricants, viscosifiers, breakers, weighting agents, inert solids, emulsifiers, emulsion thinners, emulsion thickeners, surfactants, lost circulation additives, pH control additives, buffers, crosslinkers, stabilizers, chelating agents, mutual solvents, oxidizers, reducers, consolidating agents, complexing agents, particulate materials, and any combination thereof. With the benefit of this disclosure, one of ordinary skill in the art will be able to recognize and select a suitable optional additive for use in the carrier fluid.

Furthermore, the present disclosure also provides fracturing methods in which a plurality of proppant particulates may be interrogated to determine at least one attribute concerning a plurality of fractures or the proppant particulates within the fractures. Such methods may comprise: providing a composition comprising a plurality of proppant particulates comprising a polymer material and a microdevice encapsulated within the polymer material; introducing the composition into a subterranean formation at or above a fracture gradient pressure to form a plurality of fractures therein; allowing at least a portion of the plurality of proppant particulates to settle in the plurality of fractures; and interrogating the plurality of proppant particulates to determine at least one attribute of the plurality of fractures.

In some examples, proppant particulates lacking a microdevice may be introduced into the wellbore first, followed by the proppant particulates containing the microdevice. By introducing the proppant particulates in this manner, the proppant particulates containing the microdevice may be located in a portion of the fracture nearer the wellbore, such that the microdevice may be more readily interrogated. In addition, the proppant particulates lacking the microdevice may provide a bed for setting the proppant particulates containing the microdevice, thereby lessening the likelihood of loss of the latter into a deeper portion of the formation. Optionally, proppant particulates containing a vitrimer but no microdevice may be introduced into the fractures prior to the proppant particulates containing the microdevice.

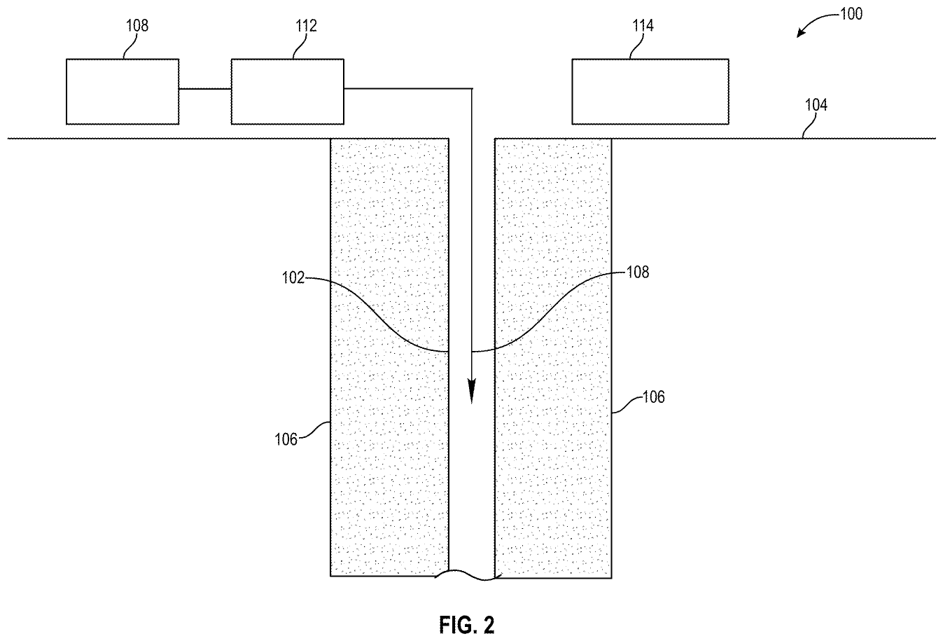

FIG. 2 is a non-limiting example of well site 100 having wellbore 102 formed through the Earth's surface 104 into subterranean formation 106 in the Earth's crust. Wellbore 102 may be vertical, horizontal, or deviated. Wellbore 102 may be openhole, but may generally be a cased wellbore. The annulus between the casing and subterranean formation 106 may be cemented. Perforations may be formed through the casing and cement into formation 106. The perforations may allow for the flow of fracturing fluid into subterranean formation 106 and for the flow of produced hydrocarbons from subterranean formation 106 into wellbore 102.

Well site 100 may have a hydraulic fracturing system including a source of fracturing fluid 108 at the Earth's surface 104 near or adjacent to wellbore 102. The source of fracturing fluid 108 may include one or more vessels holding the fracturing fluid 108. Fracturing fluid 108 may be stored in vessels or containers on the ground or on a vehicle such as a truck. Fracturing fluid 108 may comprise an aqueous fluid. For example, suitable aqueous fluids may include, but are not limited to, slick water, seawater, brine, produced water or any combination thereof. Fracturing fluid 108 may similarly comprise gel-based fluids including substances such as, but not limited to, polymers, surfactants, the like, and any combination thereof. Other additives to fracturing fluid 108 may include mineral acids, organic acids, friction reducers, emulsion breakers, emulsifiers, or any combination thereof. Fracturing fluids 108 of differing viscosity may be employed in the hydraulic fracturing operations. At least a portion of the proppant particulates within fracturing fluid 108 may be proppant particulates containing a microdevice, as set forth in the present disclosure. Optionally, a pad fluid similar in composition to fracturing fluid 108 but lacking the proppant particulates may precede introducing of fracturing fluid 108 into subterranean formation 106.

The hydraulic fracturing system at well site 100 may include motive devices, such as one or more pumps 112 to pump or inject fracturing fluid 108 through wellbore 102 into subterranean formation 106. The one or more pumps 112 may, for example, be positive displacement pumps arranged in series or parallel. In some embodiments, the speed of the one or more pumps 112 may be controlled to give a desired flow rate of fracturing fluid 108. The system may include a control component to modulate or maintain the flow of fracturing fluid 108 into wellbore 102 for hydraulic fracturing. The control component may, for example, be one or more control valves. In some implementations, the control component may be integrated into the one or more pumps 112 as a metering pump in which the speed of the pump is controlled to give the specified flow rate of fracturing fluid 108. The set point of the control component may be manually set or driven by a control system.

Fracturing fluid 108 may comprise a plurality of proppant particulates of the present disclosure suspended or otherwise dispersed therein. The hydraulic fracturing system at well site 100 may have a separate source of the proppant particulates that are added to a suitable source of carrier fluid to form fracturing fluid 108. The source of the proppant particulates may include railcars, hoppers, containers, or bins, for example. The proppant particulates may be segregated by particle size in the various source locations. The source of the proppant particulates may be at the Earth's surface 104 near or adjacent to wellbore 102. Fracturing fluid 108 may be formed in a tank or similar vessel or formed in a line as fracturing fluid 108 is being introduced to subterranean formation 106. In some implementations, the proppant particulates may be added to a conduit, such as at a suction point of a fracturing fluid pump 112. In some instances, mixtures of microdevice-containing proppant particulates may be utilized in combination with proppant particulates lacking a microdevice.

The final concentration of the plurality of proppant particulates within fracturing fluid 108 may, for example, be about 0.1 wt % to about 10 wt %, or about 0.1 wt % to about 5 wt %, or about 0.1 wt % to about 3 wt %, or about 0.1 wt % to about 1 wt %, or about 1 wt % to about 10 wt %, or about 1 wt % to about 5 wt %, or about 1 wt % to about 3 wt %, or about 3 wt % to about 10 wt %, or about 3 wt % to about 5 wt %, or about 5 wt % to about 10 wt %.

Surface equipment 114 at well site 100 may include equipment to drill a borehole to form wellbore 102. Surface equipment 114 may include a mounted drilling rig which may be a machine that creates boreholes in the Earth's subsurface. To form a hole in the ground, a drill string having a drill bit may be lowered into the hole being drilled. In operation, the drill bit may rotate to break the rock formations to form the hole as a borehole or wellbore 102. In the rotation, the drill bit may interface with the ground or subterranean formation 106 to grind, cut, scrape, shear, crush, or fracture rock to drill the hole. Surface equipment 114 may include equipment for installation and cementing of casing in the wellbore, as well as for forming perforations through wellbore 102 into subterranean formation 106. Surface equipment 114 may also include equipment to support hydraulic fracturing using fracturing fluid 108. Surface equipment 114 may also facilitate introduction of a reader into wellbore 102 to interrogate a microdevice within proppant particulates located therein.

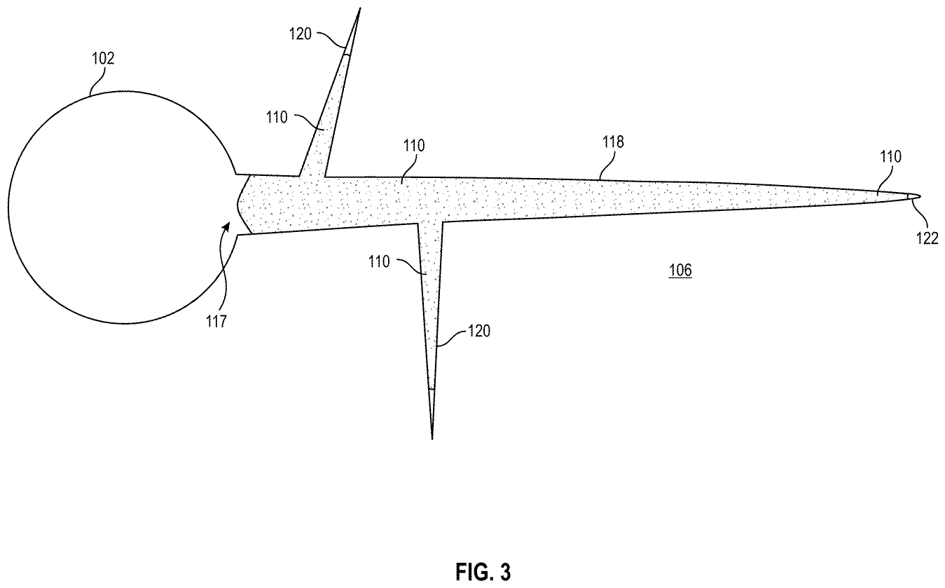

FIG. 3 is a non-limiting example of a single hydraulic fracture within a wellbore. Wellbore 102 may contain a plurality of fractures. Wellbore 102 is depicted as a circular cross-section in FIG. 3. It should be appreciated that other geometric shapes are possible in some instances. Perforation 117 may be formed through a wall of wellbore 102 into subterranean formation 106. The depicted hydraulic fracture includes primary fracture 118 and secondary fractures 120. Primary fracture 118 and secondary fractures 120 are hydraulically formed by injecting a fracturing fluid through perforation 117 into subterranean formation 106. Several more primary fractures 118 and secondary fractures 120 than depicted may be formed by the fracturing fluid at a given location within wellbore 102. Secondary fractures 120 may have a smaller fracture width than primary fracture 118.

In the illustrated embodiment, the fracturing fluid conveys a plurality of proppant particulates 110 into at least primary fracture 118. Proppant particulates 110 may approach fracture tip 122 of primary fracture 118. The distance that proppant particulates 110 reach toward fracture tip 122 may depend on the particle size of proppant particulates 110. Proppant particulates 110 may be positioned in primary fracture 118 to maintain the opening of primary fracture 118. The fracturing fluid may convey proppant particulates 110 into secondary fractures 120, as depicted, depending on the particle size of proppant particulates 110 and the fracture width of secondary fractures 120. Proppant particulates 110, if present in secondary fracture 120, may similarly maintain the opening of secondary fracture 120.

Once incorporated in primary fracture 118 and/or secondary fracture 120, interrogation of the proppant particulates 110 may be achieved by a reader, such as an RFID reader, that is introduced into the subterranean formation. The reader may be introduced by lowering the reader into the subterranean formation via a wireline or production tubing, for example. Incorporation of the reader with conventional logging tools may be used to combine the actions of interrogating the proppant particulates 110 with well logging. Alternately, the reader may be incorporated upon coiled tubing introduced to the wellbore, or the reader may be incorporated during the completion stage of a well.

Embodiments disclosed herein include:

A. Proppant particulates. The proppant particulates comprise a polymer material; and a microdevice encapsulated within the polymer material.

B. Compositions containing proppant particulates. The compositions comprise a carrier fluid; and a plurality of proppant particulates dispersed within the carrier fluid, at least a portion of the proppant particulates comprising a polymer material and a microdevice encapsulated within the polymer material.

C. Methods for fracturing a subterranean formation. The methods comprise: providing the composition of B; introducing the composition into a subterranean formation at or above a fracture gradient pressure to form a plurality of fractures therein; allowing at least a portion of the plurality of proppant particulates to settle in the plurality of fractures; and interrogating the plurality of proppant particulates to determine at least one attribute of the plurality of fractures.

Each of embodiments A, B, and C may have one or more of the following additional elements in any combination:

Element 1: wherein the polymer material comprises polyetherimide, a vitrimer, or a combination thereof.

Element 2: wherein the microdevice comprises a radio frequency identification (RFID) semiconductor chip, a microelectromechanical system (MEMS) sensor, a camera, a temperature sensor, a conductivity sensor, or any combination thereof.

Element 3: wherein the microdevice lacks a power source.

Element 4: wherein the proppant particulates further comprise a core particle, wherein the polymer material coats the core particle.

Element 5: wherein the proppant particulates have a size ranging from about 1.5 mm to about 3 mm in at least one dimension.

Element 6: wherein the polymer material is thermally stable over a temperature range of at least about 20° C. to about 240° C.

Element 7: wherein the polymer material has a compressive strength of about 30,000 psi to about 35,000 psi.

Element 8: wherein the plurality of proppant particulates is interrogated by a reader that is introduced into the subterranean formation.

Element 9: wherein the microdevice is an RFID semiconductor chip and the reader is an RFID reader.

Element 10: wherein the at least one attribute comprises a geometry of the plurality of fractures, a depth of the plurality of fractures relative to the Earth's surface, a pressure, a temperature, or any combination thereof.

Element 11: wherein the method further comprises: mapping the plurality of fractures based upon the at least one attribute.

Element 12: wherein a concentration of the plurality of the proppant particulates in the composition ranges from about 0.1 wt % to about 10 wt %.

By way of non-limiting example, exemplary combinations applicable to A, B, and C include, but are not limited to: Element 1 with Element 2; Element 1 with Element 3; Element 1 with Element 4; Element 1 with Element 5; Element 1 with Element 6; Element 1 with Element 7; Element 2 with Element 3; Element 2 with Element 4; Element 2 with Element 5; Element 2 with Element 6; Element 2 with Element 7; Element 4 with Element 5; Element 4 with Element 6; Element 4 with Element 7; Element 5 with Element 6; Element 5 with Element 7; Element 6 with element 7; Element 1 with Element 2 and Element 3; Element 1 with Element 2. Element 3, and Element 4; Element 1 with Element 2, Element 3, Element 4, and Element 5; Element 1 with Element 2, Element 3, Element 4, Element 5, and Element 6; Element 1 with Element 2, Element 3, Element 4. Element 5, Element 6, and Element 7; Element 8 with Element 9; Element 9 with Element 10; Element 9 with Element 11; Element 9 with Element 12; Element 10 with Element 11; Element 10 with Element 12; Element 11 with Element 12; Element 8 with Element 9 and Element 10; Element 8 with Element 9, Element 10, and Element 11; Element 8 with Element 9, Element 10, Element 11, and Element 12.

The present disclosure is further directed to the following non-limiting clauses:

Clause 1. Proppant particulates comprising:
a polymer material; and
a microdevice encapsulated within the polymer material.

Clause 2. The proppant particulates of clause 1, wherein the polymer material comprises polyetherimide, a vitrimer, or a combination thereof.

Clause 3. The proppant particulates of clause 1 or clause 2, wherein the microdevice comprises a radio frequency identification (RFID) semiconductor chip, a microelectromechanical system (MEMS) sensor, a camera, a temperature sensor, a conductivity sensor, or any combination thereof.

Clause 4. The proppant particulates of clause 3, wherein the microdevice lacks a power source.

Clause 5. The proppant particulates of any one of clauses 1-4, further comprising: a core particle, wherein the polymer material coats the core particle.

Clause 6. The proppant particulates of any one of clauses 1-5, wherein the proppant particulates have a size ranging from about 1.5 mm to about 3 mm in at least one direction.

Clause 7. The proppant particulates of any one of clauses 1-6, wherein the polymer material is thermally stable over a temperature range of at least about 20° C. to about 240° C.

Clause 8. The proppant particulates of any one of clauses 1-7, wherein the polymer material has a compressive strength of about 30,000 psi to about 35,000 psi.

Clause 9. A composition comprising:
a carrier fluid; and
a plurality of proppant particulates dispersed within the carrier fluid, at least a portion of the proppant particulates comprising a polymer material and a microdevice encapsulated within the polymer material.

Clause 10. A method comprising:
providing the composition of clause 9;
introducing the plurality of the proppant particulates into a subterranean formation at or above a fracture gradient pressure to form a plurality of fractures therein;
allowing at least a portion of the plurality of proppant particulates to settle in the plurality of fractures; and
interrogating the plurality of proppant particulates to determine at least one attribute of the plurality of fractures.

Clause 11. The method of clause 10, wherein the plurality of proppant particulates is interrogated by a reader that is introduced into the subterranean formation.

Clause 12. The method of clause 11, wherein the microdevice is an RFID semiconductor chip and reader is an RFID reader.

Clause 13. The method of any one of clauses 10-12, wherein the at least one attribute comprises a geometry of the plurality of fractures, a depth of the plurality of fractures relative to the Earth's surface, a pressure, a temperature, or any combination thereof.

Clause 14. The method of any one of clauses 10-13, further comprising:
mapping the plurality of fractures based upon the at least one attribute.

Clause 15. The method of any one of clauses 10-14, wherein a concentration of the plurality of the proppant particulates in the composition ranges from about 0.1 wt % to about 10 wt %.

Clause 16. The method of any one of clauses 10-15, wherein the polymer material comprises a polyetherimide, a vitrimer, or a combination thereof.

Clause 17. The method of any one of clauses 10-16, wherein the microdevice comprises an RFID semiconductor chip, a MEMS sensor, a camera, a temperature sensor, a conductivity sensor, or any combination thereof.

Clause 18. The method of clause 17, wherein the microdevice lacks a power source.

Clause 19. The method of any one of clauses 10-18, wherein the polymer material is thermally stable over a temperature range of at least about 20° C. to about 240° C.

Clause 20. The method of any one of clauses 10-19, wherein the polymer material has a compressive strength of about 30,000 psi to about 35,000 psi.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

1. Proppant particulates comprising:
a microdevice and a polymer material, the microdevice being located i) within a coating surrounding a core particle and comprising the polymer material, or ii) within the polymer material in a particle lacking a core particle;
wherein the proppant particulates have a size ranging from about 2 mm to about 3 mm in at least one dimension.

2. The proppant particulates of claim 1, wherein the polymer material comprises polyetherimide, a vitrimer, or a combination thereof.

3. The proppant particulates of claim 1, wherein the microdevice comprises a radio frequency identification (RFID) semiconductor chip, a microelectromechanical system (MEMS) sensor, a camera, a temperature sensor, a conductivity sensor, or any combination thereof.

4. The proppant particulates of claim 3, wherein the microdevice lacks a power source.

5. The proppant particulates of claim 1,
wherein the core particle is present.

6. (canceled)

7. The proppant particulates of claim 1, wherein the polymer material is thermally stable over a temperature range of at least about 20° C. to about 240° C.

8. The proppant particulates of claim 1, wherein the polymer material has a compressive strength of about 30,000 psi to about 35,000 psi.

9. A composition comprising:
a carrier fluid; and
a plurality of proppant particulates dispersed within the carrier fluid, at least a portion of the proppant particulates comprising a microdevice and a polymer material, the microdevice being located i) within a coating surrounding a core particle and comprising the polymer material, or ii) within the polymer material in a particle lacking a core particle;
wherein the proppant particulates have a size ranging from about 2 mm to about 3 mm in at least one dimension.

10. A method comprising:
providing the composition of claim 9;
introducing the composition into a subterranean formation at or above a fracture gradient pressure to form a plurality of fractures therein;
allowing at least a portion of the plurality of proppant particulates to settle in the plurality of fractures; and
interrogating the plurality of proppant particulates to determine at least one attribute of the plurality of fractures.

11. The method of claim 10, wherein the plurality of proppant particulates is interrogated by a reader that is introduced into the subterranean formation.

12. The method of claim 11, wherein the microdevice is an RFID semiconductor chip and the reader is an RFID reader.

13. The method of claim 10, wherein the at least one attribute comprises a geometry of the plurality of fractures, a depth of the plurality of fractures relative to the Earth's surface, a pressure, a temperature, or any combination thereof.

14. The method of claim 10, further comprising:
mapping the plurality of fractures based upon the at least one attribute.

15. The method of claim 10, wherein a concentration of the plurality of the proppant particulates in the composition ranges from about 0.1 wt % to about 10 wt %.

16. The method of claim 10, wherein the polymer material comprises polyetherimide, a vitrimer, or a combination thereof.

17. The method of claim 10, wherein the microdevice comprises a radio frequency identification (RFID) semiconductor chip, a microelectromechanical system (MEMS) sensor, a camera, a temperature sensor, a conductivity sensor, or any combination thereof.

18. The method of claim 17, wherein the microdevice lacks a power source.

19. The method of claim 10, wherein the polymer material is thermally stable over a temperature range of at least about 20° C. to about 240° C.

20. The method of claim 10, wherein the polymer material has a compressive strength of about 30,000 psi to about 35,000 psi.
